(19) United States
(12) Patent Application Publication
(10) Pub. No.: US 2025/0070340 A1
(43) Pub. Date: Feb. 27, 2025

(54) CELL, BATTERY MODULE AND BATTERY PACK

(71) Applicant: AESC Japan Ltd., Kanagawa (JP)

(72) Inventors: Tianqi Lu, Jiangsu (CN); Jie Zhang, Jiangsu (CN)

(73) Assignee: AESC Japan Ltd., Kanagawa (JP)

(21) Appl. No.: 18/531,613

(22) Filed: Dec. 6, 2023

(30) Foreign Application Priority Data
Aug. 23, 2023 (CN) 202322275807.3

(51) Int. Cl. H01M 50/169; H01M 50/103; H01M 50/15; H01M 50/209; H01M 50/588; H01M 50/595

(52) U.S. Cl. CPC H01M 50/169; H01M 50/103; H01M 50/15; H01M 50/209; H01M 50/588; H01M 50/595

(57) ABSTRACT

A cell and a battery module are provided. The cell includes an outer casing, a cover plate, and a reinforcing member. The cover plate is welded to a top portion of the outer casing. The reinforcing member at least includes a first surface and a second surface. The first surface is fixedly connected to one of the cover plate and the outer casing, and the second surface faces the other one of the cover plate and the outer casing.

### CROSS-REFERENCE TO RELATED APPLICATION

This application claims the priority benefit of China application serial no. 202322275807.3, filed on Aug. 23, 2023. The entirety of the above-mentioned patent application is hereby incorporated by reference herein and made a part of this specification.

### BACKGROUND

### Technical Field

The disclosure belongs to the technical field of batteries, and in particular, relates to a cell, a battery module and a battery pack.

### Description of Related Art

In a conventional square casing cell, the assembly of the top cover and the aluminum casing relies on the embedding of the side steps of the aluminum casing and the surrounding steps below the top cover piece, and laser welding is then performed to complete the assembly of the casing and the cover. The square casing cell uses the aluminum casing as a current collector container. When the cell is charged and discharged, gas will be produced and the electrode sheets will expand, causing the aluminum casing to be pushed outward and expand. The gas produced by the cell, the expansion of the electrode sheets, and resulting outward expansion of the aluminum casing cause the welded seam of the casing cover at the corresponding position to be torn. Long-term exposure to the fatigue expansion force may cause the strength of the welded seam of the casing cover to be weakened, or the welded seam may even be torn and fails, so the safety of the cell is thus affected.

### SUMMARY

In view of the abovementioned shortcomings of the related art, the disclosure aims to provide a cell and a battery module, so as to address the problems of cell safety being affected, strength of a casing cover welded seam being weakened, and the casing cover welded seam being torn and failing caused by long-term exposure to a fatigue expansion force as the casing cover welded seam at the corresponding position is torn by the outward expansion of an aluminum casing resulted from generation of gas and expansion of electrode sheets when the cell is charged and discharged.

To achieve the above and other related purposes, the disclosure provides a cell including an outer casing, a cover plate, and a reinforcing member.

The cover plate is welded to a top portion of the outer casing.

The reinforcing member at least includes a first surface and a second surface. The first surface is fixedly connected to one of the cover plate and the outer casing, and the second surface faces the other one of the cover plate and the outer casing.

In an embodiment of the disclosure, the cell further includes an electrode assembly stacked in the outer casing in a thickness direction, a length direction, or a height direction of the cell. When the electrode assembly is stacked in the thickness direction, the first surface is fixedly connected to the cover plate, and the second surface faces a large surface of the outer casing.

When the electrode assembly is stacked in the length direction, the first surface is fixedly connected to the cover plate, and the second surface faces a narrow surface of the outer casing.

When the electrode assembly is stacked in the height direction, the first surface is fixedly connected to the outer casing, and the second surface faces the cover plate.

In an embodiment of the disclosure, the reinforcing member is a L-shaped reinforcing member, a C-shaped reinforcing member, a T-shaped reinforcing member, or an annular reinforcing member.

In an embodiment of the disclosure, a ratio of a length of each of the L-shaped reinforcing member, the C-shaped reinforcing member, and the T-shaped reinforcing member to a length of the cover plate is less than or equal to 1.

In an embodiment of the disclosure, a width of the L-shaped reinforcing member on the cover plate close to an explosion-proof valve is less than or equal to (a−b)/2, where a is a width of the cover plate and b is a width of the explosion-proof valve.

In an embodiment of the disclosure, each of the L-shaped reinforcing member, the C-shaped reinforcing member, and the T-shaped reinforcing member includes a plurality of segmented reinforcing members, and the plurality of segmented reinforcing members are arranged at intervals.

In an embodiment of the disclosure, the C-shaped reinforcing member further includes a third surface, and the third surface and the second surface face two opposite large surfaces of the outer casing respectively. An escape groove is provided on the first surface, and the escape groove faces an explosion-proof valve on the cover plate.

In an embodiment of the disclosure, the cell further includes a top patch, a groove is provided on a side of the top patch close to the reinforcing member to form an escape zone, and a portion of the reinforcing member arranged on the cover plate is located in the escape zone.

In an embodiment of the disclosure, an insulating layer including a heat shrinkable sleeve film, an insulating tape, or a blue film is further provided. The heat shrinkable sleeve film surrounds a top portion top of the cell and covers a surface of the reinforcing member. The insulating tape or the blue film is attached to the surface of the reinforcing member.

In an embodiment of the disclosure, two ends of the insulating tape or the blue film protrude from two ends of the reinforcing member, and portions protruding from the reinforcing member are folded and cover side surfaces of the reinforcing member.

The disclosure further provides a battery module including a casing body, a cell stack, and reinforcing members.

The cell stack includes a plurality of cells, and each of the cells includes an outer casing and a cover plate welded to a top portion of the outer casing.

The reinforcing members are at least arranged on outer sides of the two outermost cells of the cell stack, and each of the reinforcing members at least includes a first surface and a second surface. Herein, the first surface is fixedly connected to one of the cover plate and the outer casing, and the second surface faces the other one of the cover plate and the outer casing.

In an embodiment of the disclosure, each of the cells are provided with one of the reinforcing members.

In an embodiment of the disclosure, the cell stack includes an even number of single cell groups. Each of the single cell groups includes at least one of the cells, and the single cell groups are connected in series.

In an embodiment of the disclosure, the cell stack includes a plurality of single cell groups. The reinforcing members are provided on the two cells located on two sides of each of the single cell groups.

In an embodiment of the disclosure, a T-shaped reinforcing member is arranged on sides close to each other of adjacent two of the adjacent single cell groups. The T-shaped reinforcing member includes a wing plate, a sub-plate, two first surfaces, and two second surfaces. The two second surfaces are respectively arranged on two sides of the sub-plate, and the two first surfaces are respectively arranged on a bottom portion of the wing plate on the two sides of the sub-plate.

The disclosure further provides a battery pack including the cell as described above or the battery module as described above.

The disclosure provides a cell, a battery module and a battery pack. By arranging the reinforcing member on the cell, the problem of cyclic cracking caused by insufficient strength of the welded seam is solved. Further, the relative displacement between the casing body and the top cover of the cell is limited, so it is ensured that the welded seam does not fail during the cycle, the casing cover welded seam is effectively protected, and the swelled cell is protected. Further, the reinforcing member is connected to the cover plate and the casing body through laser welding or gluing, so an additional device is not required, and the operation is easy and efficient.

The disclosure provides a cell, a battery module and a battery pack. By providing the escape design on the top cover patch and the targeted coating and covering of the reinforcing member, the problem of aluminum exposure on one side edge of the top cover caused by the welding of the reinforcing member is solved. A good external insulation effect is thereby provided, and the external insulation performance of the cell is thus ensured.

The disclosure provides a cell, a battery module and a battery pack. By arranging the reinforcing members on at least the outer sides of the two outermost cells of the cell stack in the battery module, the relative displacement between the casing bodies and the top covers of the outermost cells ensures that the welded seam does not fail during the cyclic swelling of the cells, so the safety of the battery module is improved.

The disclosure provides a cell, a battery module and a battery pack. When the cell stack includes an even number of the cells and the positive and negative electrodes of the cells are arranged in an alternating manner, the L-shaped reinforcing members are provided only on the outer sides of the two outermost cells of the cell stack. In this way, the welded seam is ensured not to fail during the cyclic swelling process of the cells. Further, when the number of the cells is an even number, the two outermost cells are completely identical, so only one production line is needed to produce the cells with the reinforcing members, and production costs may be effectively reduced.

### BRIEF DESCRIPTION OF THE DRAWINGS

To make the technical solutions provided in the embodiments of the disclosure more clearly illustrated, several accompanying drawings required by the embodiments for description are briefly introduced as follows. Obviously, the drawings in the following description are merely several embodiments of the disclosure, and for a person having ordinary skill in the art, other drawings can be obtained based on these drawings without inventive effort.

FIG. 1 is a schematic structural view of a cell with a L-shaped reinforcing member according to an embodiment of the disclosure.

FIG. 2 is a schematic structural view of the L-shaped reinforcing member according to an embodiment of the disclosure.

FIG. 3 is a schematic cross-sectional structural view of the L-shaped reinforcing member being welded according to an embodiment of the disclosure.

FIG. 4 is a schematic cross-sectional structural view of the L-shaped reinforcing member being glued according to an embodiment of the disclosure.

FIG. 5 is a schematic structural view of the cell with a C-shaped reinforcing member according to an embodiment of the disclosure.

FIG. 6 is a schematic structural view of the C-shaped reinforcing member according to an embodiment of the disclosure.

FIG. 7 is a schematic cross-sectional structural view of the cell with the C-shaped reinforcing member according to an embodiment of the disclosure.

FIG. 8 is a schematic structural view of the cell with a T-shaped reinforcing member according to an embodiment of the disclosure.

FIG. 9 is a schematic structural view of the T-shaped reinforcing member according to an embodiment of the disclosure.

FIG. 10 is a schematic cross-sectional structural view of the cell with the T-shaped reinforcing member according to an embodiment of the disclosure.

FIG. 11 is a schematic structural view of the cell with two reinforcing members according to an embodiment of the disclosure.

FIG. 12 is a schematic structural view of a segmented C-shaped reinforcing member according to an embodiment of the disclosure.

FIG. 13 is a schematic structural view of a segmented T-shaped reinforcing member according to an embodiment of the disclosure.

FIG. 14 is a schematic structural view of the cell with an annular reinforcing member according to an embodiment of the disclosure.

FIG. 15 is a schematic structural view of the annular reinforcing member according to an embodiment of the disclosure.

FIG. 16 is a schematic exploded view of a top patch matched with a reinforcing member according to an embodiment of the disclosure.

FIG. 17 is a schematic local view of the top patch matched with the reinforcing member according to an embodiment of the disclosure.

FIG. 18 is a schematic exploded view of the top patch matched with the reinforcing member according to another embodiment of the disclosure.

FIG. 19 is a schematic cross-sectional view of the top patch matched with the reinforcing member according to another embodiment of the disclosure.

FIG. 20 is a schematic exploded view of the reinforcing member matched with an insulating tape according to an embodiment of the disclosure.

FIG. 21 is a schematic cross-sectional view of the reinforcing member matched with the insulating tape according to an embodiment of the disclosure.

FIG. 22 is a schematic local view of the reinforcing member matched with the insulating tape according to an embodiment of the disclosure.

FIG. 23 is a schematic cross-sectional view of the reinforcing member matched with the insulating tape of FIG. 22.

FIG. 24 is a schematic structural view of a battery module with L-shaped reinforcing members according to an embodiment of the disclosure.

FIG. 25 is a schematic structural view of the battery module with the L-shaped reinforcing members according to another embodiment of the disclosure.

FIG. 26 is a schematic structural view of the battery module with C-shaped reinforcing members according to an embodiment of the disclosure.

FIG. 27 is a schematic structural view of the battery module with the C-shaped reinforcing members according to another embodiment of the disclosure.

FIG. 28 is a schematic structural view of the battery module with T-shaped reinforcing members according to an embodiment of the disclosure.

FIG. 29 is a schematic structural view of the battery module with the T-shaped reinforcing members according to another embodiment of the disclosure.

FIG. 30 is a schematic structural view of the battery module with annular reinforcing members according to an embodiment of the disclosure.

FIG. 31 is a schematic structural view of the battery module with the annular reinforcing members according to another embodiment of the disclosure.

### DESCRIPTION OF THE EMBODIMENTS

The implementation of the disclosure is illustrated below by specific embodiments. A person having ordinary skill in the art can easily understand other advantages and effects of the disclosure from the content disclosed in this specification. The disclosure can also be implemented or applied through other different specific implementation ways. The details in this specification can also be modified or changed based on different viewpoints and applications without departing from the spirit of the disclosure.

It should be noted that the drawings provided in the embodiments are merely schematically illustrating the basic idea of the disclosure. Therefore, the drawings only show components related to the disclosure rather than drawings which are depicted according to the numbers, shapes, and sizes of the components in actual implementation. In actual implementation, the types, numbers, and proportions of the components can be changed arbitrarily, and the component layout type may also be more complex.

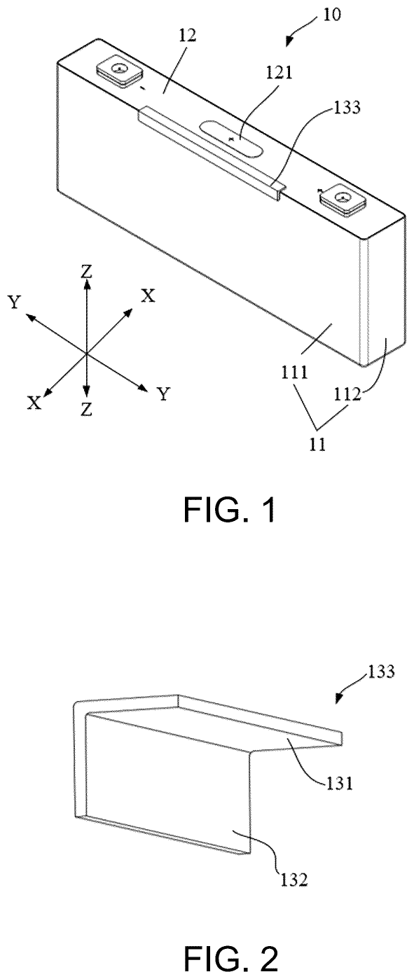

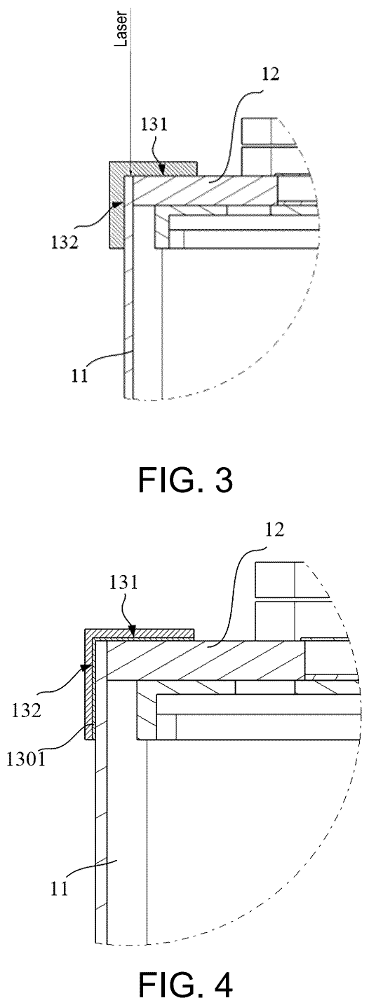

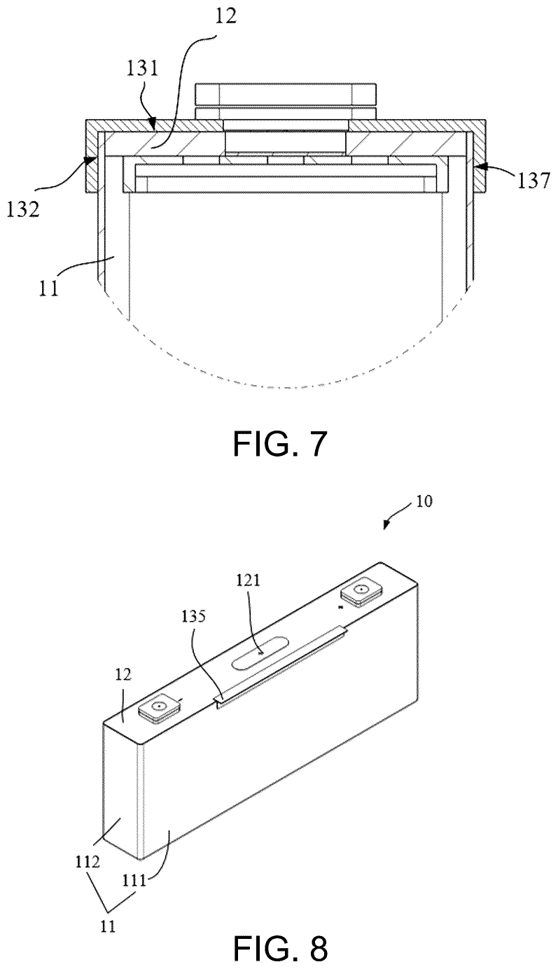

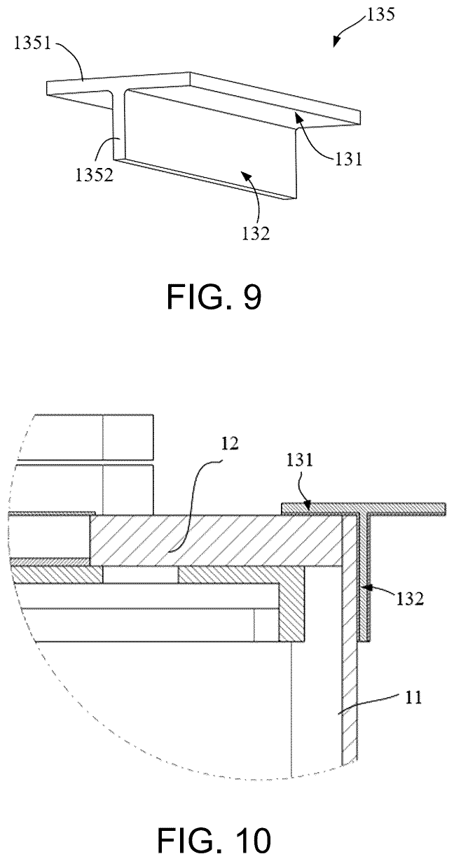

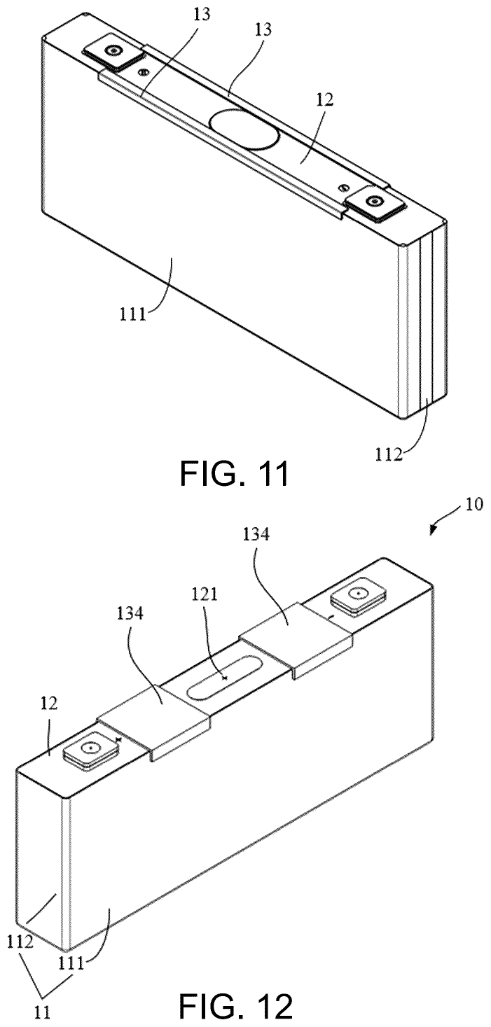

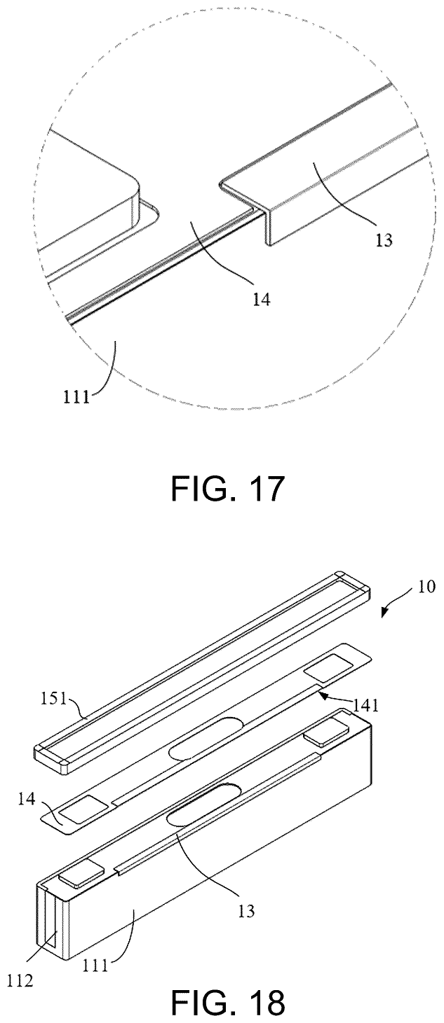

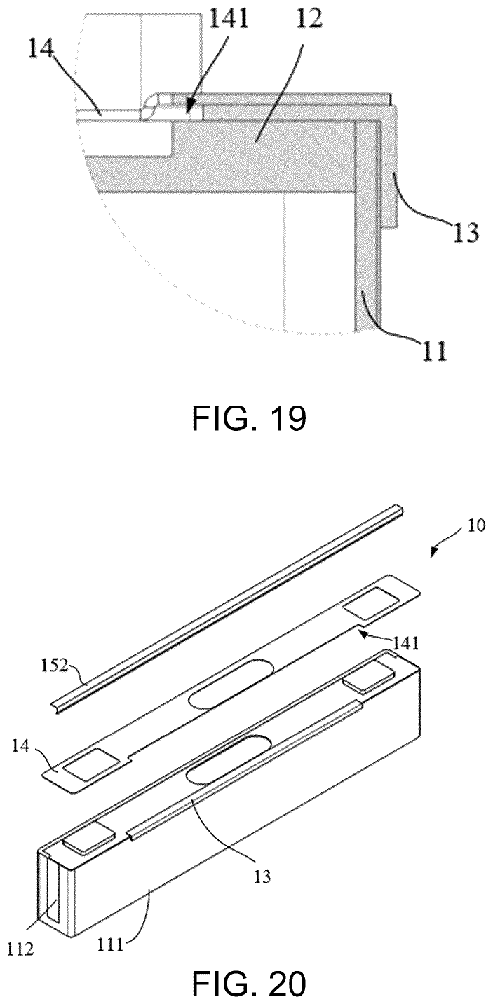

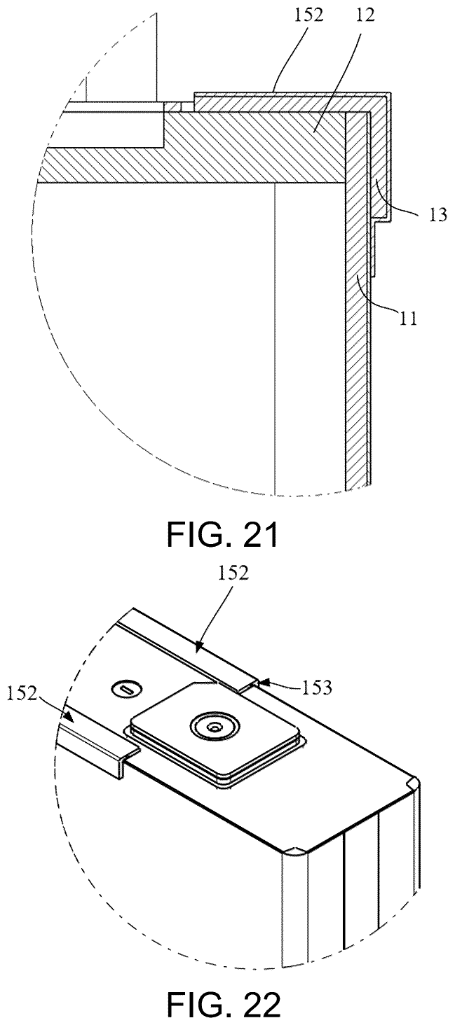

With reference to FIG. 1 to FIG. 23, the disclosure provides a cell, a battery module and a battery pack, so as to address the problems of cell safety being affected, strength of a casing cover welded seam being weakened, and the casing cover welded seam being torn and failing caused by long-term exposure to a fatigue expansion force as the casing cover welded seam at the corresponding position is torn by the outward expansion of an aluminum casing resulted from generation of gas and expansion of electrode sheets when the cell is charged and discharged. To be specific, a cell 10 includes an outer casing 11, a cover plate 12, and a reinforcing member 13, and a top portion of the outer casing 11 is provided with an opening. The cover plate 12 is installed on the top portion of outer casing 11, and specifically, is installed at the opening on the top portion of the outer casing 11 and is welded and fixed to the outer casing 11. The reinforcing member 13 is arranged between the cover plate 12 and the outer casing 11 and is configured to improve strength of a welded seam between the cover plate 12 and the outer casing 11.

With reference to FIG. 1 to FIG. 23, in this embodiment, the reinforcing member 13 at least includes a first surface 131 and a second surface 132. The first surface 131 is fixedly connected to one of the cover plate 12 and the outer casing 11, and the second surface 132 faces the other one of the cover plate 12 and the outer casing 11. Preferably, the second surface 132 faces the cover plate 12 or the outer casing 11 from the front. For instance, the first surface 131 is fixedly connected to the cover plate 12, and the second surface 132 faces a surface of the outer casing 11 from the front. Alternatively, the first surface 131 is fixedly connected to the outer casing 11, and the second surface 132 faces the cover plate 12 from the front. It should be noted that in this embodiment, the first surface 131 and the cover plate 12 or the outer casing 11 may be connected by laser welding or gluing. The second surface 132 and the outer casing 11 or the cover plate 12 may be connected by laser welding or gluing or may be arranged directly opposite each other and are not fixedly connected to each other. In this way, when the cell 10 swells, the swelling of the cell 10 is limited, so that the relative displacement of the outer casing 11 and the cover plate 12 in the cell 10 is limited, so it is ensured that the welded seam does not fail during the cycle, and a casing cover welded seam is effectively protected. It should be noted that in this embodiment, a ratio of an aspect ratio of the cell 10 is greater than 12, and the cell under this aspect ratio is more likely to swell, thereby causing the casing cover welded seam to fail. Therefore, the reinforcing member 13 is provided on the cell 10, so as to limit the swelling of the cell 10 when the cell 10 swells.

With reference to FIG. 1 to FIG. 23, in this embodiment, the cell 10 further includes an electrode assembly stacked in the outer casing 11. For instance, the electrode assembly may be stacked in a thickness direction X, a length direction Y, or a height direction Z of the cell. When the electrode assembly is stacked in the thickness direction, the first surface 131 is fixedly connected to the cover plate 12, and the second surface 132 faces a large surface 111 of the outer casing 11. When the electrode assembly is stacked in the length direction, the first surface 131 is fixedly connected to the cover plate 12, and the second surface 132 faces a narrow surface 112 of the outer casing 11. When the electrode assembly is stacked in the height direction, the first surface 131 is fixedly connected to the outer casing 11, and the second surface 132 faces the cover plate 12. That is, the first surface 131 is configured to fix and install the reinforcing member 13, and the second surface 132 is configured to limit the relative displacement of the outer casing 11 and the cover plate 12 in the cell 10, so that it is ensured that the welded seam does not fail during the cycle, and the casing cover welded seam is effectively protected.

With reference to FIG. 1 to FIG. 23, in this embodiment, the reinforcing member 13 may be any one of a L-shaped reinforcing member 133, a C-shaped reinforcing member 134, a T-shaped reinforcing member 135, and an annular reinforcing member 136. The reinforcing member 13 may be connected to the cover plate 12 and the outer casing 11 through laser welding or glue 1301, so an additional device is not required, and it is easy and efficient to operate.

With reference to FIG. 1 to FIG. 4 and FIG. 8 to FIG. 10, in this embodiment, the first surface 131 being fixedly connected to the cover plate 12 and the second surface 132 facing the large surface 111 of the outer casing 11 is taken as an example for description. The L-shaped reinforcing member 133 includes one first surface 131 and one second surface 132. The first surface 131 and the second surface are located on one side of the first surface 131 and are bent opposite to the first surface 131. The first surface 131 is welded and fixed to the cover plate 12 through laser welding, and the second surface 132 faces the large surface 111 of the outer casing 11. The T-shaped reinforcing member 135 includes a wing plate 1351, a sub-plate 1352, two first surfaces 131, and two second surfaces 132. The two second surfaces 132 are arranged respectively on two sides of the sub-plate 1352, and the two second surfaces 132 are respectively arranged on a bottom portion of the wing plate 1351 on the two sides of the sub-plate 1352. Preferably, the sub-plate 1352 and the wing plate 1352 are arranged perpendicularly to each other. For instance, the T-shaped reinforcing member 135 may be disposed between two cells 10. The two first surfaces 131 are welded and fixed to the cover plates 12 of the two cells 10 through laser welding respectively, and the two second surfaces 132 face the large surfaces 111 of the outer casings 11 of the two cells 10 respectively, so that one T-shaped reinforcing member 135 may limit the outward expansion of the large surfaces 111 of the outer casings 11 of the two cells 10 together. In some other embodiments, the first surface 131 and the second surface 132 may be fixedly connected to the cover plate 12 and the large surface 111 of the outer casing 11 respectively through the glue 1301.

With reference to FIG. 1 to FIG. 10, in this embodiment, a ratio of a length of each of the L-shaped reinforcing member 133, the C-shaped reinforcing member 134, and the T-shaped reinforcing member 135 to a length of the cover plate 12 is set to be less than or equal to 1. That is, the lengths of the L-shaped reinforcing member 133, the C-shaped reinforcing member 134, and the T-shaped reinforcing member T 135 are less than the length of the cover plate 12. Further, a width of a contact zone between the reinforcing member 13 and the outer casing 11 is set to be between 1 mm and 10 mm to ensure that the reinforcing member 13 limits the swelling of the cell 10. Further, a width of the L-shaped reinforcing member 133 on the cover plate 12 close to an explosion-proof valve 121 is less than or equal to (a−b)/2, where a is a width of the cover plate 12 and b is a width of the explosion-proof valve 121, so that the L-shaped reinforcing member 133 is prevented from interfering with the explosion-proof valve 121. In some embodiments, a ratio of a height of the second surface 132 of the reinforcing member 13 to a height of the outer casing 11 of the cell is greater than 3%, and a width of the first surface 131 of the reinforcing member 13 is greater than one-tenth of the width of the cover plate. In this way, it is ensured that the reinforcing member 13 may be reliably fixed onto the cell 10 and the reliability of limiting the swelling of the cell 10 may be ensured.

With reference to FIG. 1 to FIG. 11, in this embodiment, one large surface 111 of the outer casing 11 may be provided with the L-shaped reinforcing member 133 or the T-shaped reinforcing member 13, or two large surfaces 111 of the outer casing 11 may both be provided with the L-shaped reinforcing members 133 or T-shaped reinforcing members 135.

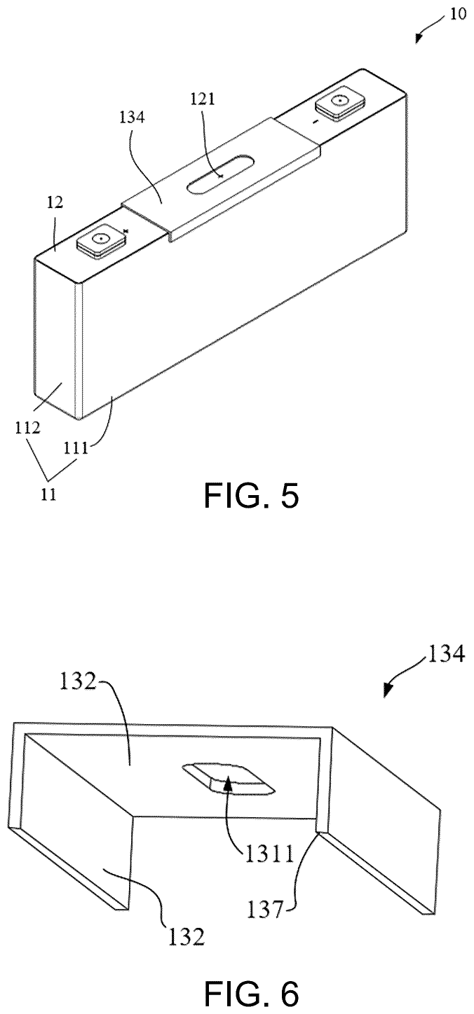

With reference to FIG. 5 to FIG. 7, in this embodiment, the C-shaped reinforcing member 134 further includes a third surface 137. The second surface 132 and the third surface 137 are respectively located on two sides of the first surface 131 and are bent relative to the first surface 131. Preferably, the second surface 132 and the third surface 137 are both perpendicular to the first surface 137, and the third surface 137 and the second surface 132 face the two opposite large surfaces 111 of the outer casing 1 respectively. Further, an escape groove 1311 is provided on the first surface 13, and the escape groove 1311 faces the explosion-proof valve 121 on the cover plate 12 to avoid the explosion-proof valve 121. Certainly, in some other embodiments, the C-shaped reinforcing member 134 may also be configured as a segmented structure. That is, the C-shaped reinforcing member 134 includes a plurality of segmented reinforcing members, and the plurality of segmented reinforcing members are arranged at intervals to avoid the explosion-proof valve 121. Further, the segmented reinforcing members may be arranged to target a key zone of the welded seam between the cover plate 12 and the outer casing 11, so that the casing cover welded seam may be effectively protected.

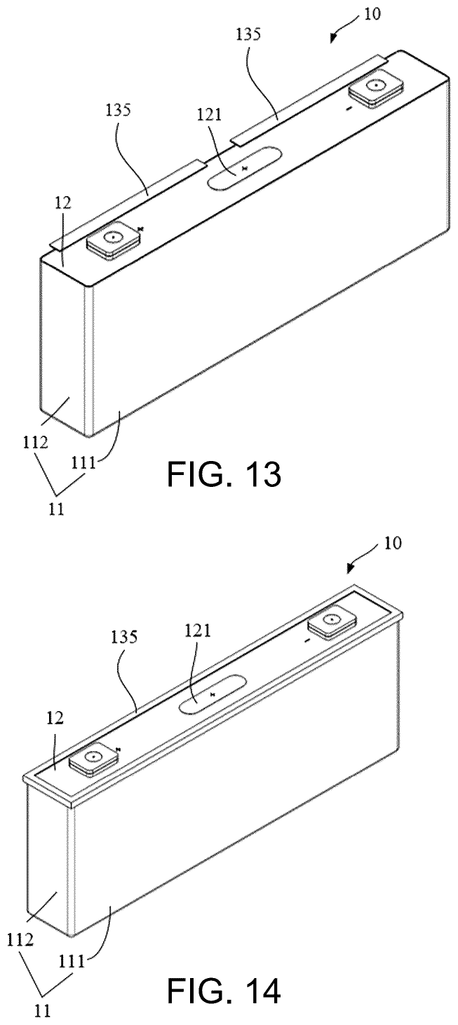

With reference to FIG. 12 and FIG. 13, in this embodiment, each of the L-shaped reinforcing member 133 and the T-shaped reinforcing member 135 may be configured as a segmented structure as well. That is, each of the L-shaped reinforcing member 133 and the T-shaped reinforcing member 135 includes a plurality of segmented reinforcing members respectively. The segmented reinforcing members may be arranged at intervals to target the key zone of the welded seam between the cover plate 12 and the outer casing 11, so that the casing cover welded seam may be effectively protected.

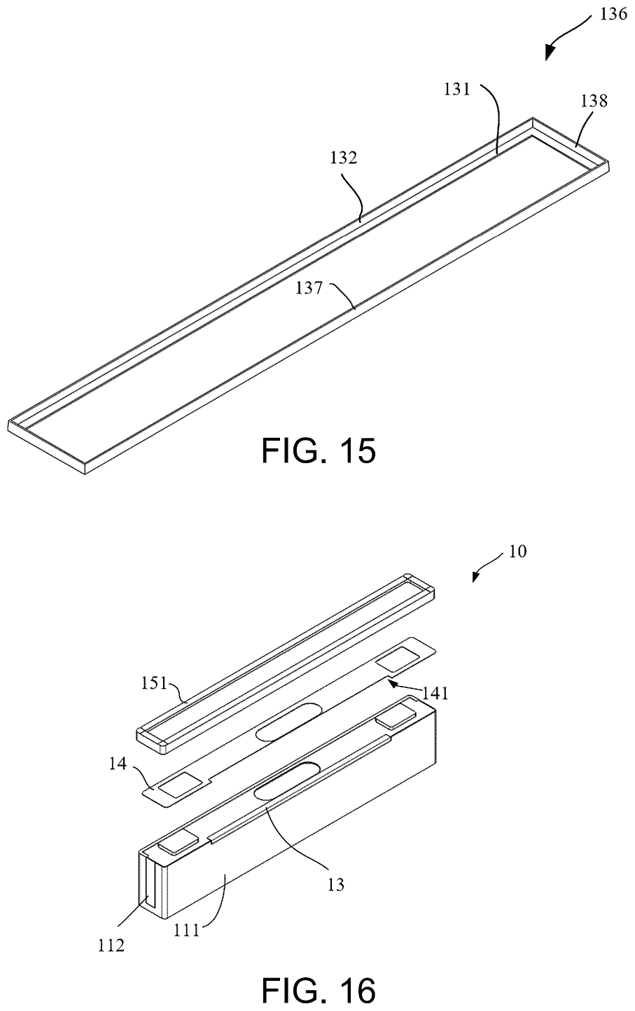

With reference to FIG. 14 and FIG. 15, in this embodiment, the annular reinforcing member 136 surrounds the welded part of the outer casing 11 and the cover plate 12 to wrap the welded seam between the outer casing 11 and the cover plate 12, so that the relative displacement of the outer casing 11 and the cover plate 12 is limited, and the welded seam is ensured not to fail during the cycle, and that the casing cover welded seam is effectively protected. For instance, the annular reinforcing member 136 includes the first surface 131, the second surface 132, the third surface 137, and two opposite fourth surfaces 138. Herein, the second surface 132 and the third surface 137 are respectively located on two sides of the first surface 131, the fourth surfaces 138 are located on the other two sides of the first surface 131, and the second surface 132, the third surface 137, and the fourth surfaces 138 are bent relative to the first surface 131. Preferably, the second surface 132, the third surface 137, and the fourth surfaces 138 are respectively perpendicularly to the first surface 131, and the first surface 131 is fixedly connected to the cover plate 12. The third surface 137 and the second surface 132 face the two opposite large surfaces 111 of the outer casing 11 respectively. The two opposite fourth surfaces 138 face the two opposite narrow surfaces 112 of the outer casing 11 respectively, so that the relative displacement of the outer casing 11 and the cover plate 12 is limited, and the casing cover welded seam is effectively protected.

It should be noted that after the reinforcing member 13 is welded, the reinforcing member 13 occupies an envelope space of a side surface and a top surface of an original cell, that is, the reinforcing member 13 occupies the space on the side and top surfaces of the original cell. The raised part forms a plurality of outer surfaces, making insulation application more difficult and making conventional top patches, blue film structures, and gluing methods no longer applicable. The main body or part of the reinforcing member is exposed, an external insulating exposure point is formed, so the risk of external short circuit increases significantly, and the insulation performance of the cell is affected. In particular, the side surface of the reinforcing member 13 greatly increase the difficulty of insulating film application. Therefore, an escape zone 141 is provided on a top patch 14, and to be specific, a groove is provided on a side of the top patch 14 close to the reinforcing member 13 to form the escape zone 141. For instance, the groove is formed by partially cutting a side of the top patch 14 close to the reinforcing member 13. A shape of the groove matches a shape of a portion of the reinforcing member 13 arranged on the cover plate 12, and an insulating layer is added to the reinforcing member 13 to ensure its insulation performance. In some other embodiments, the escape zone 141 may also be formed by performing corresponding heat pressing on a local zone of the top patch 14 close to one side of the reinforcing member 13 to form a protrusion.

With reference to FIG. 16 to FIG. 19, in this embodiment, the portion of the reinforcing member 13 provided on the cover plate 12 is located in the escape zone 141. For instance, the reinforcing member 13 is a L-shaped reinforcing member 133, and the portion of the L-shaped reinforcing member 133 provided on the cover plate 12 is located in the escape zone 141. Further, an insulating layer is provided on a surface of the reinforcing member 13 to solve the problem of aluminum exposure on one side edge of the top cover caused by the welding of the reinforcing member 13, so that a good external insulation effect is provided, and the external insulation performance of the cell is ensured. To be specific, the insulating layer may be provided as a heat shrinkable sleeve film 151. The heat shrinkable sleeve film 151 surrounds a top portion top of the cell 10 and covers the surface of the reinforcing member 13. By heating and shrinking, the heat shrinkable sleeve film 151 is attached around the top portion of the cell 10 to cover the top patch 1, and insulation protection is thereby achieved.

With reference to FIG. 20 to FIG. 23, in another embodiment, the insulating layer may also be configured as an insulating material such as an insulating tape 152 or a blue film and is attached to the surface of the reinforcing member 13. Two ends of the insulating tape 152 or the blue film protrude from two ends of the reinforcing member 13, and portions protruding from the reinforcing member 13 are folded and cover side surfaces of the reinforcing member 13. It should be noted that the side surfaces of the reinforcing member 13 are special-shaped surfaces when the insulating film is applied. It is difficult to form the insulating film at one time, and it is easy to form exposed points, so the risk of insulation increases. Therefore, in this embodiment, when the portions of the insulating tape 152 or the blue film protruding from the reinforcing member 13 are folded and cover the side surfaces of the reinforcing member 13, two layers of insulating tape 152 or blue film and other insulating materials are formed on bent portions 153 on the side surfaces of the reinforcing member 13, so as to better ensure that the insulating layer completely covers an exposed surface of the reinforcing member 13, and a good external insulation effect is provided.

In some other embodiments, after the reinforcing member 13 is processed and formed, the surface of the reinforcing member 13 has insulating capability by addition of a heating shrinkable insulating sleeve, integral immersing, or insulating material spraying. As described above, after the reinforcing member 13 is welded, the insulating layer is attached to its exposed surface, so that its external insulation effect is further improved.

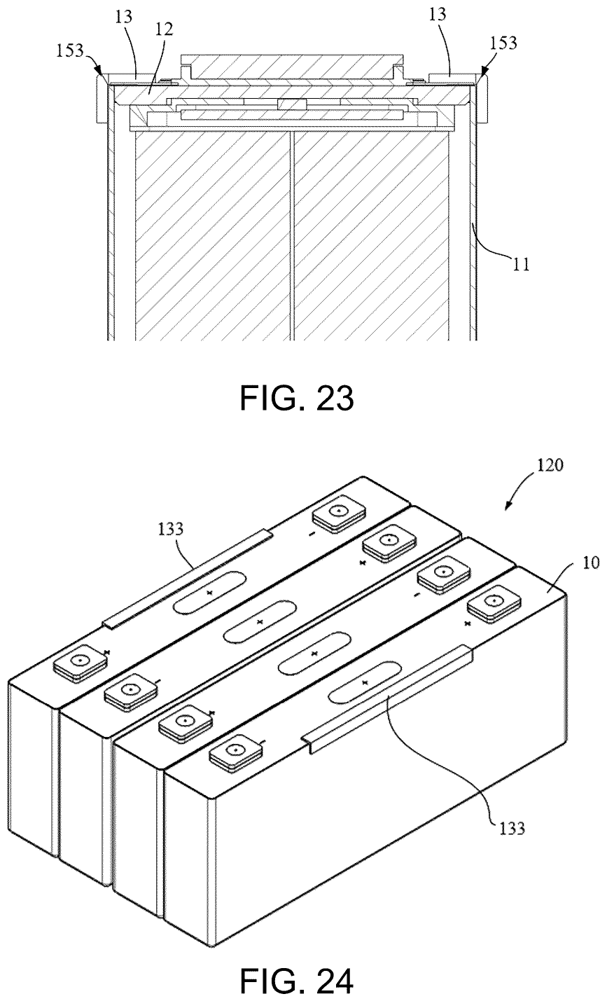

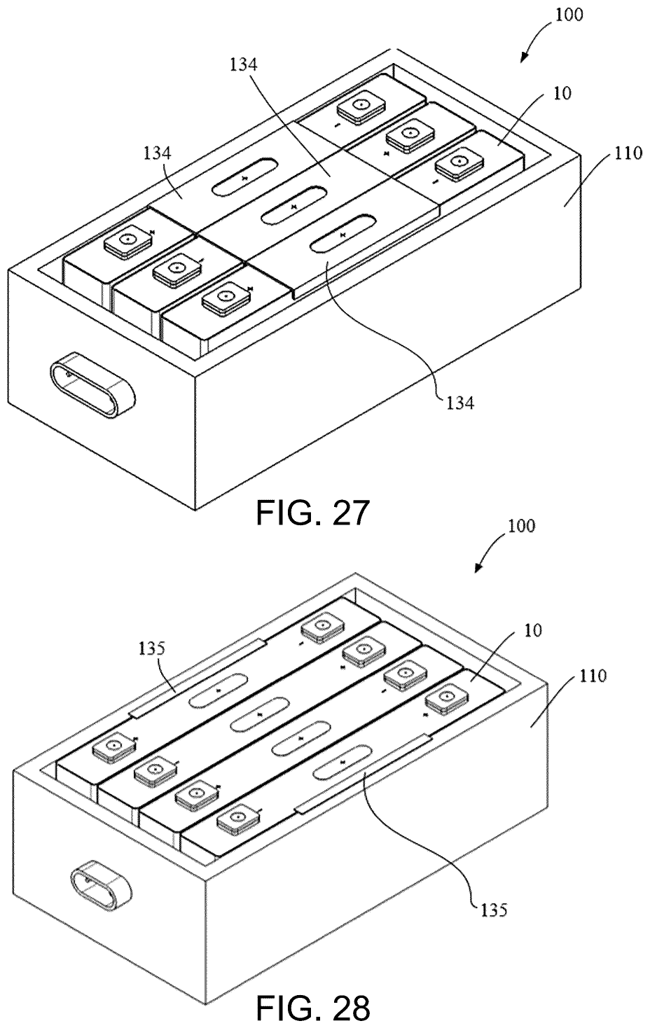

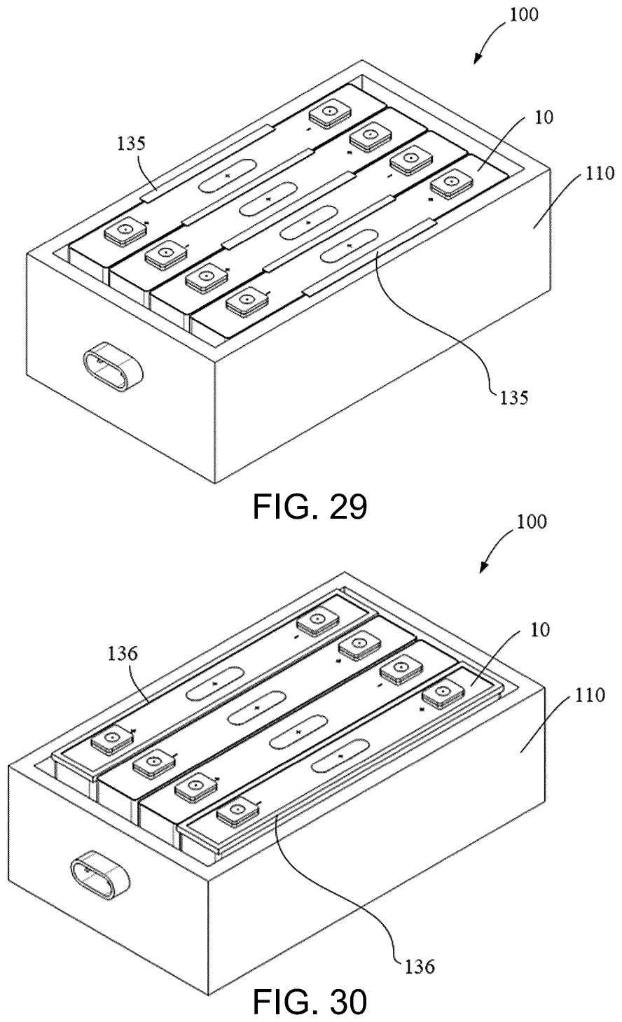

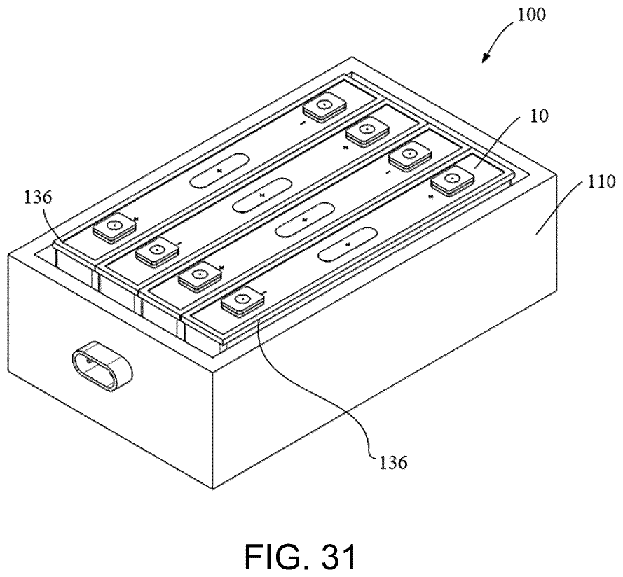

With reference to FIG. 24 to FIG. 31, the disclosure further provides a battery module. A battery module 100 includes a casing body 110, a cell stack 120, and reinforcing members 13. The cell stack 120 is installed in the casing body 110 and includes a plurality of cells 10 stacked together. In the battery module 10, the swelling of outer surfaces of the two outermost cells 10 in the cell stack 120 is most obvious. As such, the relative displacement between an outer casing 11 and a cover plate 12 located outside the two outermost cells 10 is relatively large, so that a welded seam at this location is most susceptible to failure during the cyclic swelling process. Therefore, in this embodiment, the reinforcing members 13 at least are provided on the outer sides of the two outermost cells 10 of the cell stack 120. The outermost two cells 10 refer to the two cells 10 located on both sides of the cell stack 120, and the outer sides of the cells 10 refer to large surfaces 111 of the cells close to the casing body 110. It should be noted that in other embodiments, each of the cells 10 may be provided with one of the reinforcing members 13. With reference to FIG. 1 to FIG. 23, in this embodiment, each reinforcing member 13 may be any one of a L-shaped reinforcing member 133, a C-shaped reinforcing member 134, a T-shaped reinforcing member 135, and an annular reinforcing member 136.

With reference to FIG. 24, in this embodiment, the cell stack 120 includes a plurality of single cell groups. Each of the single cell groups includes at least one of the cells 10, and the single cell groups are connected in series or in parallel. In this embodiment, the number of the single cell groups is preferably an even number, and the plurality of single cell groups are preferably connected in series. That is, the cell stack includes an even number of cells 10 connected in series, and positive and negative electrodes of the even number of cells 10 connected in series are arranged in an alternating manner. Herein, each of the reinforcing members 13 is preferably a L-shaped reinforcing member 133 or a T-shaped reinforcing member 135. Herein, the two outermost cells 10 in the cell stack 120 are completely identical and may share a single production line for production. Further, the reinforcing members 13 require the least consumable materials, so the reinforcing members 13 can effectively protect a casing cover welded seam and protect the swelled cells, and its production costs are also preferably reduced.

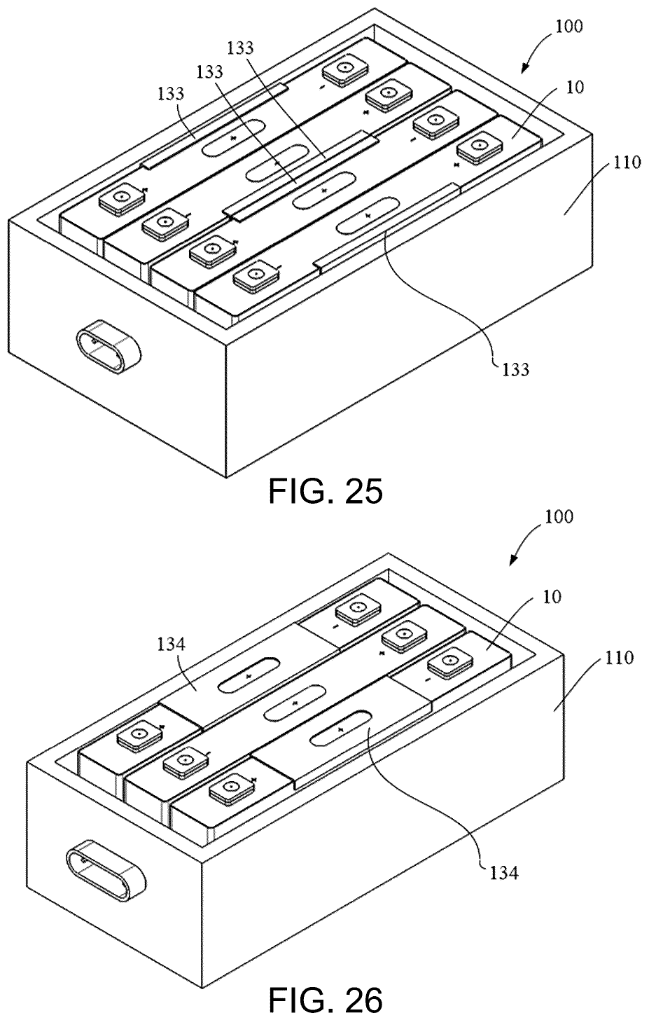

With reference to FIG. 25, in this embodiment, the reinforcing members 13 may be provided on the two cells 10 located on two sides of each of the single cell groups. The plurality of cells 10 in each single cell group are connected in series or in parallel. For instance, taking the single cell group including two mutually stacked cells 10 as an example, the reinforcing members 13 are provided on the sides of the two cells 10 away from each other in the single cell group, and the reinforcing members 13 are preferably the L-shaped reinforcing members 133. In some other embodiments, one T-shaped reinforcing member 135 is arranged on sides close to each other of the two adjacent single cell groups. That is, the T-shaped reinforcing member 135 is located between two adjacent cells 10 in the two adjacent single cell groups, so that one T-shaped reinforcing member 135 can limit the outward swelling of two cells 10 at the same time.

With reference to FIG. 26, in some other embodiments, when the total number of cells in the plurality of single cell groups is an odd number, that is, when the number of cells 10 in the cell stack 120 is an odd number, or when the number of cells 10 is set to an even number and the positive and negative electrodes of the plurality of cells 10 are arranged on the same side, the reinforcing members 13 are preferably the C-shaped reinforcing members 134 or the annular reinforcing members 136. Herein, the two outermost cells 10 in the cell stack 120 are completely identical and may share a single production line for production. The reinforcing members 13 therefore can effectively protect the casing cover welded seam and protect the swelled cells, and its production costs are also preferably reduced. It should be noted that in this embodiment, when the plurality of cells 10 are connected in series, the positive and negative electrodes of the plurality of cells 10 are preferably arranged in an alternating manner. When the plurality of cells 10 are connected in parallel, the positive and negative electrodes of the plurality of cells 10 are preferably arranged on the same side.

The disclosure further provides a battery pack including the cell as described above or the battery module as described above.

The disclosure provides a cell, a battery module and a battery pack. By arranging the reinforcing member on the cell, the problem of cyclic cracking caused by insufficient strength of the welded seam is solved. Further, the relative displacement between the casing body and the top cover of the cell is limited, so it is ensured that the welded seam does not fail during the cycle, the casing cover welded seam is effectively protected, and the swelled cell is protected. Further, the reinforcing member is connected to the cover plate and the casing body through laser welding or gluing, so an additional device is not required, and the operation is easy and efficient.

The disclosure provides a cell, a battery module and a battery pack. By providing the escape design on the top cover patch and the targeted coating and covering of the reinforcing member, the problem of aluminum exposure on one side edge of the top cover caused by the welding of the reinforcing member is solved. A good external insulation effect is thereby provided, and the external insulation performance of the cell is thus ensured.

The disclosure provides a cell, a battery module and a battery pack. By arranging the reinforcing members on at least the outer sides of the two outermost cells of the cell stack in the battery module, the relative displacement between the casing bodies and the top covers of the outermost cells ensures that the welded seam does not fail during the cyclic swelling of the cells, so the safety of the battery module is improved.

The disclosure provides a cell, a battery module and a battery pack. When the cell stack includes an even number of the cells and the positive and negative electrodes of the cells are arranged in an alternating manner, the L-shaped reinforcing members are provided only on the outer sides of the two outermost cells of the cell stack. In this way, the welded seam is ensured not to fail during the cyclic swelling process of the cells. Further, when the number of the cells is an even number, the two outermost cells are completely identical, so only one production line is needed to produce the cells with the reinforcing members, and production costs may be effectively reduced.

It should be noted that the “plurality” described in the above embodiments includes two and more than two. Further, in the embodiments, the “faces” in which a specific surface of the reinforcing member faces the cover plate or the outer casing means that a specific surface of the reinforcing member falls on the cover plate along a projection perpendicular to the cover plate, or a specific surface of the reinforcing member falls on the large surface or the narrow surface along the projection perpendicular to the large surface or the narrow surface of the outer casing. For example, “the second surface faces the large surface of the outer casing” means that the second surface of the reinforcing member falls on the large surface along a projection perpendicular to the large surface.

The above description is only preferred embodiments of the disclosure and an illustration of the applied technical principle. A person having ordinary skill in the art shall understand that the scope involved in the disclosure is not limited to the technical solutions formed by specific combinations of the above technical features and shall also cover other technical solutions formed by any combination of the above technical features or their equivalent features without departing from the concept of the disclosure, for example, technical solutions formed by (but not limited to) replacing the above features with technical features disclosed in the disclosure with similar functions.

Except for the technical features in the specification, the rest of the technical features are known technologies by a person having ordinary skill in the art. In order to highlight the innovative features of the disclosure, the rest of the technical features will not be repeated herein.

What is claimed is:

1. A cell, comprising:
an outer casing;
a cover plate welded to a top portion of the outer casing; and
a reinforcing member at least comprising a first surface and a second surface, wherein the first surface is fixedly connected to one of the cover plate and the outer casing, and the second surface faces the other one of the cover plate and the outer casing.

2. The cell according to claim 1, wherein the cell further comprises an electrode assembly stacked in the outer casing in a thickness direction, a length direction, or a height direction of the cell, wherein
when the electrode assembly is stacked in the thickness direction, the first surface is fixedly connected to the cover plate, and the second surface faces a large surface of the outer casing,
when the electrode assembly is stacked in the length direction, the first surface is fixedly connected to the cover plate, and the second surface faces a narrow surface of the outer casing, and
when the electrode assembly is stacked in the height direction, the first surface is fixedly connected to the outer casing, and the second surface faces the cover plate.

3. The cell according to claim 2, wherein the reinforcing member is a L-shaped reinforcing member, a C-shaped reinforcing member, a T-shaped reinforcing member, or an annular reinforcing member.

4. The cell according to claim 3, wherein a ratio of a length of each of the L-shaped reinforcing member, the C-shaped reinforcing member, and the T-shaped reinforcing member to a length of the cover plate is less than or equal to 1.

5. The cell according to claim 3, wherein a width of the L-shaped reinforcing member on the cover plate close to an explosion-proof valve is less than or equal to (a−b)/2, where a is a width of the cover plate and b is a width of the explosion-proof valve.

6. The cell according to claim 3, wherein each of the L-shaped reinforcing member, the C-shaped reinforcing member, and the T-shaped reinforcing member comprises a plurality of segmented reinforcing members, and the plurality of segmented reinforcing members are arranged at intervals.

7. The cell according to claim 3, wherein the C-shaped reinforcing member further comprises a third surface, the third surface and the second surface face two opposite large surfaces of the outer casing respectively, an escape groove is provided on the first surface, and the escape groove faces an explosion-proof valve on the cover plate.

8. The cell according to claim 1, wherein the cell further comprises a top patch, a groove is provided on a side of the top patch close to the reinforcing member to form an escape zone, and a portion of the reinforcing member arranged on the cover plate is located in the escape zone.

9. The cell according to claim 8, further comprising an insulating layer that comprises a heat shrinkable sleeve film, an insulating tape, or a blue film, wherein the heat shrinkable sleeve film surrounds a top portion top of the cell and covers a surface of the reinforcing member, and the insulating tape or the blue film is attached to the surface of the reinforcing member.

10. The cell according to claim 9, wherein two ends of the insulating tape or the blue film protrude from two ends of the reinforcing member, and portions protruding from the reinforcing member are folded and cover side surfaces of the reinforcing member.

11. A battery module, comprising:
a casing body;
a cell stack comprising a plurality of cells, wherein each of the cells comprises an outer casing and a cover plate welded to a top portion of the outer casing; and
reinforcing members at least arranged on outer sides of the two outermost cells of the cell stack, wherein each of the reinforcing members at least comprises a first surface and a second surface, wherein the first surface is fixedly connected to one of the cover plate and the outer casing, and the second surface faces the other one of the cover plate and the outer casing.

12. The battery module according to claim 11, wherein each of the cells are provided with one of the reinforcing members.

13. The battery module according to claim 11, wherein the cell stack comprises an even number of single cell groups, each of the single cell groups comprises at least one of the cells, and the single cell groups are connected in series.

14. The battery module according to claim 11, wherein the cell stack comprises a plurality of single cell groups, and the reinforcing members are provided on the two cells located on two sides of each of the single cell groups.

15. The battery module according to claim 13, wherein a T-shaped reinforcing member is arranged on sides close to each other of adjacent two of the single cell groups, the T-shaped reinforcing member comprises a wing plate, a sub-plate, two first surfaces, and two second surfaces, the two second surfaces are respectively arranged on two sides of the sub-plate, and the two first surfaces are respectively arranged on a bottom portion of the wing plate on the two sides of the sub-plate.

16. The battery module according to claim 14, wherein a T-shaped reinforcing member is arranged on sides close to each other of adjacent two of the single cell groups, the T-shaped reinforcing member comprises a wing plate, a sub-plate, two first surfaces, and two second surfaces, the two second surfaces are respectively arranged on two sides of the sub-plate, and the two first surfaces are respectively arranged on a bottom portion of the wing plate on the two sides of the sub-plate.

17. A battery pack, comprising the cell according to claim 1.

18. A battery pack, comprising the battery module according to claim 11.
